(19) United States
(12) Patent Application Publication
(10) Pub. No.: US 2026/0050229 A1
(43) Pub. Date: Feb. 19, 2026

(54) CORONA TREATMENT APPARATUS

(71) Applicant: Canon Production Printing Holding B.V., Venlo (NL)

(72) Inventor: Sandor H.G. JOPPEN, Venlo (NL)

(73) Assignee: Canon Production Printing Holding B.V., Venlo (NL)

(21) Appl. No.: 19/293,666

(22) Filed: Aug. 7, 2025

(30) Foreign Application Priority Data
Aug. 14, 2024 (EP) 24194475.0

(51) Int. Cl. G03G 15/02

(52) U.S. Cl. CPC G03G 15/0266; G03G 15/0283; G03G 2215/00759

(57) ABSTRACT

A corona treatment apparatus comprising a conveyor (10) for moving substrate sheets to be treated along a transport path (12), a plurality of corona electrodes (24) arranged along the transport path (12) on a first side of this transport path, at least one ground electrode (26) arranged opposite to the corona electrodes (24) on an opposite second side of the transport path, and a voltage-controlled power supply circuit (30) to which the corona electrodes (24) are connected in parallel characterized in that a control circuit (38) is provided for limiting a discharge current flowing through each individual corona electrode (24).

### BACKGROUND OF THE INVENTION

### 1. Field of the Invention

The invention relates to a corona treatment apparatus comprising a conveyor for moving substrate sheets to be treated along a transport path, a plurality of corona electrodes arranged along the transport path on a first side of this transport path, and at least one ground electrode arranged opposite to the corona electrodes on an opposite second side of the transport path, and a voltage-controlled power supply circuit to which the corona electrodes (24) are connected in parallel.

Such treatment apparatus is used for example in the printing industry for subjecting media sheets to a corona treatment before printing, in order to modify the surface energy of the sheets and thereby to improve the wettability of the sheet surface with liquid ink.

### 2. Description of the Related Art

An example of a known corona treatment apparatus has been described in WO 2013 104753 A2. This apparatus has a plurality of corona electrodes disposed along the transport path of the conveyor, so that a high treatment intensity can be achieved while the sheets are moved with a relatively high velocity in order to enhance production.

US 2015/266311 A1 discloses a treatment apparatus in which the voltage of each corona electrode is controlled by a separate voltage source.

JP 2024 008724 A deals with the problem that neighboring corona electrodes may become short-circuited.

### SUMMARY OF THE INVENTION

It is an object of the invention to provide a corona treatment apparatus with improved efficiency in the treatment of cut sheets.

In order to achieve this object, the treatment apparatus according to the invention is characterized in that a control circuit is provided for limiting a discharge current flowing through each individual corona electrode.

When, in the corona treatment of cut sheets, individual sheets are successively moved past the corona electrodes, the individual sheets are separated by certain gaps. When a corona electrode faces such a gap, the discharge current through that electrode is higher than in the case where the discharge path is blocked by the sheet material. If the voltage of the power source is constant, this increase in discharge current causes an increased power consumption and an increased temperature of the ground electrode, leading to an undesired heat transfer from the ground electrode to the sheets. If all corona electrodes are connected to a common power supply that has a constant power output, a substantial portion of the output power will be deviated to the idle electrodes that are facing a gap and have a higher discharge current, so that less power is available for the adjacent electrodes that are still facing the edge of the sheet. This results in an edge effect through which the corona treatment of the edge portions of the sheets becomes less efficient. Since, in the apparatus according to the invention, the current flow through each individual electrode is limited, the discharge current of the idle electrodes can be prevented from becoming excessively high, so that the edge effect as well as an increased power consumption can be avoided.

More specific details and further developments of the invention are indicated in the dependent claims.

There are various ways for limiting the discharge current in the idle electrodes. One possibility is to simply disconnect each electrode from the power supply in the time interval in which a gap between two sheets passes the respective electrode. A sheet detector may be provided for detecting the leading and/or trailing edges of the sheets.

If the discharge current of each individual electrode is monitored, the increase in the discharge current at the moment when the trailing edge of a sheet passes the electrode can be used as a detection signal that causes the electrode to be disconnected from the power source. If the widths of the gaps between the successive sheets and the transport velocity of the sheets are known, then it is possible to calculate the length of a time interval after which the electrode should be switched on again. In that case, no sheet detector would be needed.

In another embodiment, all corona electrodes may permanently be connected to the power source, but the supply line to each electrode includes a current limiter circuit comprising a current detector and, e.g., a transistor controlled by the current detection signal. In that case, the electrodes may be active even in the periods in which a gap between the sheets passes the electrode, but an increase in current will be prevented by the current limiter circuit.

### BRIEF DESCRIPTION OF THE DRAWINGS

Embodiment examples will now be described in conjunction with the drawings, wherein:

FIG. 1 is a sketch of a corona treatment apparatus according to the invention.

FIGS. 2 to 5 are circuit diagrams illustrating the function of control circuits in one embodiment of the invention.

FIG. 6 is a circuit diagram of control circuits according to a modified embodiment; and

FIG. 7 is a circuit diagrams of a control circuit according to a further embodiment.

### DETAILED DESCRIPTION OF EMBODIMENTS

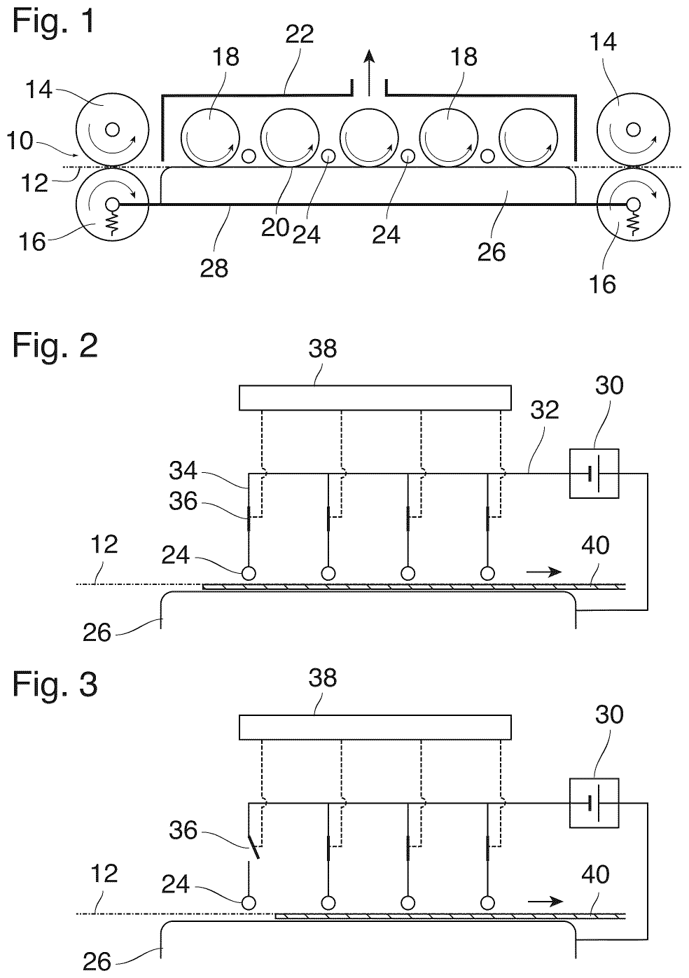

As shown in FIG. 1, a corona treatment apparatus comprises a conveyor 10 for conveying media sheets to be treated along a sheet transport path 12. In the example shown, the conveyor is formed by two pairs of rollers 14,16, each pair forming a nip through which the media sheets pass through. In the space between the two roller pairs, a number of support elements 18 in the form of rollers are arranged above the sheet transport path 12 which is thus defined by the lower contact lines of the upper rollers 14 of the conveyor and the support elements 18, which contact lines are substantially parallel to the axes of the upper rollers 14 or substantially parallel to the axes of the support elements 18, respectively. Since the support elements 18 are separated by certain spacings, their lower contact lines form an air-permeable support surface 20 for the media sheets moving along the sheet transport path 12. This support surface 20 forms the bottom of a suction box 22 to which a suction pressure is applied for attracting the media sheets upwards against the air-permeable support surface 20.

A number of rod-like or wire-like corona electrodes 24 are arranged to extend across the sheet transport path 12 and are interleaved with the support elements 18. The corona electrodes 24 cooperate with a ground electrode 26 disposed on the opposite side of the sheet transport path 12. In operation, a high voltage is applied to the corona electrodes 24, so that corona discharges occur between each of the corona electrodes 24 and the ground electrode 26. Thus, when media sheets pass through the apparatus, the top surface of the media sheets is subjected to a corona treatment that results in an increase of the surface energy of the sheets. The efficiency of the corona treatment depends on the number of corona electrodes 24 and also depends critically upon the distance between the corona electrodes and the sheet surface. The corona electrodes 24 have been arranged such that the corona electrodes 24 are spaced apart from the support surface 20 by a specified distance that assures an optimal efficiency of the corona discharges. This distance is independent from the sheet thickness because the sheets are sucked against the support surface 20 and are lifted off from the ground electrode 26.

The ground electrode 26 is rigidly mounted on a frame 28 in which the lower rollers 16 of the conveyor 10 are rotatably supported. The ground electrode 26 has a flat top surface which is approximately level with the top contact lines of the rollers 16, which top contact lines are substantially parallel to the axes of rollers 16. The entire unit comprising the frame 28, the lower rollers 16 of the conveyor and the ground electrode 26 is elastically biased upwards so that, when no media sheets are present, the lower rollers 16 engage the upper rollers 14 while the top surface of the ground electrode 26 does not quite contact the support elements 18.

FIG. 2 is a circuit diagram showing the corona electrodes 24 and the ground electrode 26 connected to a power supply circuit 30. A supply line 32 leading from the power supply circuit 30 to the corona electrodes 24 branches into four branch lines 34, one for each corona electrode, and each branch line includes a switch 36 that may be opened for disconnecting that particular electrode from the power supply. The switching states of the switches 36 are controlled by an electronic control circuit 38.

In the condition shown in FIG. 2, a sheet 40 is moved on the sheet transport path 12 in the direction indicated by an arrow and passes through the gaps between each corona electrode 24 and the ground electrode 26. Since all four of these gaps are blocked to some extent by the material of the sheet 40, the discharge current flowing through each corona electrode 24 is limited to a value that depends upon the output voltage of the power supply circuit 30.

FIG. 3 illustrates a situation where a trailing edge of the sheet 40 has passed the first corona electrode 24, so that the discharge gap of this electrode is no longer blocked by the sheet, which would normally lead to a significant increase of the discharge current through that electrode. If, for example, the power supply circuit 30 would be of a type in which the output power is feedback controlled, the output voltage would drop in order to compensate for the increased current in one of the four corona electrodes. As a consequence, the discharge current and hence the treatment intensity at the other three corona electrons with drop. In order to avoid this undesired effect, the control circuit 38 has opened the switch 36 associated with the first corona electrode 24 that does no longer “see” the sheet 40. The control circuit 38 may also be configured to change the target value for the output power of the power supply circuit 30 so that the output power may be adapted to the reduced number of active corona electrodes. As an alternative, the power supply circuit 30 may be of a type in which not the output power but the output voltage is feedback controlled. Then, the target value for the output voltage may be left unchanged, which results in an unchanged treatment intensity of all active corona electrodes regardless of the number of electrodes that have been switched off.

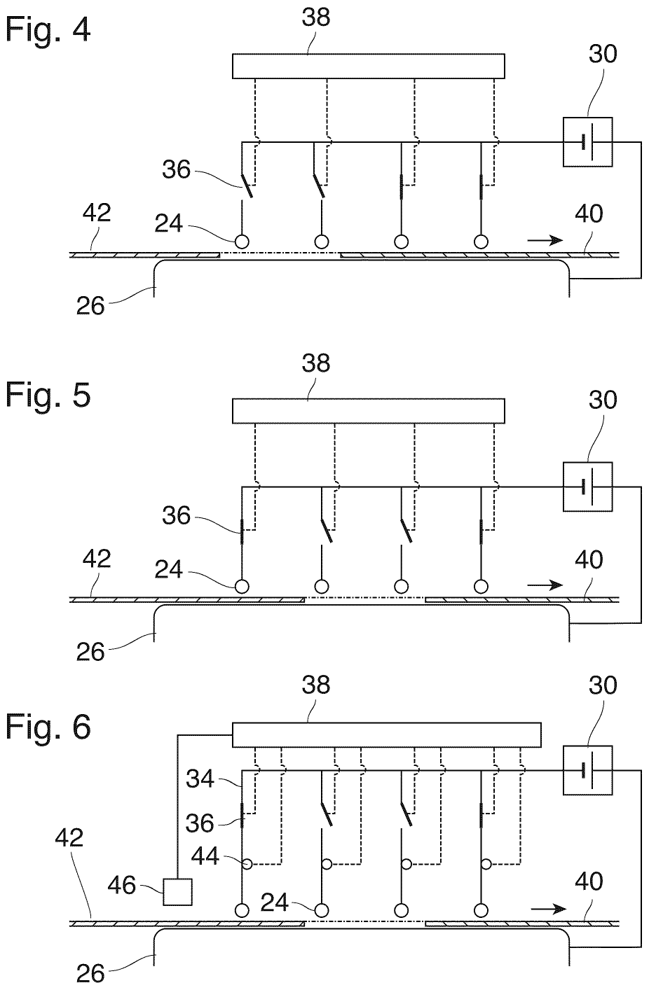

FIG. 4 illustrates the situation where the sheet 40 has moved on and the trailing edge has passed the second corona electrode while the leading edge of another sheet 42 is approaching the first corona electrode. In this situation, both the first and the second corona electrodes have been switched off.

In FIG. 5, the sheets 40, 42 have moved on, and the second and third corona electrode have been switched off because they are now facing the gap between the two sheets, while the leading edge of the sheet 42 has passed the first electrode which has therefore been switched on again.

It will be understood that the control circuit 38 receives, from the conveyor 10, a velocity signal indicating the transport velocity of the sheets 40, 42, and a feed mechanism that is used for feeding the sheets onto the conveyor provides a timing signal indicating the time when the leading edge of the sheet has reached a reference point at a fixed distance from the corona treatment apparatus. Thus, since the length of the sheets 40, 42 is known, the control circuit 38 can keep track of the movements of the gaps between the sheets to determine the appropriate switching timings of the switches 36. Thus, the functionality of the control circuit 38 assures a uniform corona treatment on the entire surface of each sheet without any edge effects. Further, by switching off the corona electrodes 24 that are not needed, the power consumption is reduced and the ground electrode 26 is prevented from being heated by an excessive current.

FIG. 6 shows a modified embodiment, in which each of the branch lines 34 includes a current detector 44 connected in series with the switch 36. When the trailing edge of a sheet passes an electrode, the associated current detector 44 detects a rise of the discharge current and sends a signal to the control circuit 38 which will then open the corresponding switch 36. Further, a sheet detector 46 is arranged to send a signal to the control circuit 38 when the leading edge of a sheet approaches the corona treatment apparatus. Since the transport velocity of the sheets is known as well as the fixed distances between the sheet detector 46 and the corona electrodes 24, the control circuit 36 can determine the timings when the switches 36 have to be closed again.

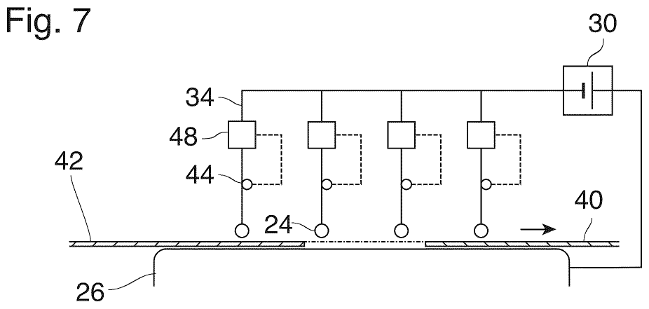

FIG. 7 illustrates another embodiment in which a control circuit for limiting the discharge currents takes the form of electronic current limiters 48, which replace the switches 36 in the previous embodiments and are controlled by signals from the current detectors 44. In this embodiment, the corona electrodes that are facing the gap between the sheets are not switched off, so that it is not necessary to keep track of the movements of the sheets 40, 42. Instead, the corona electrodes are constantly active, but the current limiters 46 prevent an increase of the discharge current and therewith an edge effect as well as excessive power consumption.

1. A corona treatment apparatus comprising a conveyor for moving substrate sheets to be treated along a transport path, a plurality of corona electrodes arranged along the transport path on a first side of this transport path, at least one ground electrode arranged opposite to the corona electrodes on an opposite second side of the transport path, and a voltage-controlled power supply circuit to which the corona electrodes are connected in parallel wherein a control circuit is provided for limiting a discharge current flowing through each individual corona electrode.

2. The apparatus according to claim 1, wherein the control circuit is configured to switch each corona electrode off at a timing when a trailing edge of the sheet passes that electrode, and to switch the corona electrode on again at a timing when a leading edge of a subsequent sheet reaches the electrode.

3. The apparatus according to claim 2, wherein current detectors are provided for measuring a discharge current through each of the corona electrodes, and the control circuit is configured to switch the corona electrode off when the associated current detector signals a rise in the discharge current.

4. The apparatus according to claim 1, comprising at least one sheet detector connected to the control circuit.

5. The apparatus according to claim 1, wherein each corona electrode is connected in series with a current limiter for limiting the current flowing through that individual corona electrode.

6. The apparatus according to claim 2, comprising at least one sheet detector connected to the control circuit.

7. The apparatus according to claim 3, comprising at least one sheet detector connected to the control circuit
